(19) United States
(12) Patent Application Publication
(10) Pub. No.: US 2013/0148204 A1
(43) Pub. Date: Jun. 13, 2013

(54) STOWABLE LIGHT SHADE

(71) Applicant: Mitchell Lynn Allen, Southlake, TX (US)

(72) Inventor: Mitchell Lynn Allen, Southlake, TX (US)

(21) Appl. No.: 13/315,874

(22) Filed: Dec. 9, 2011

(51) Int. Cl. G02B 27/00; B23P 11/00

(52) U.S. Cl. 359/601; 29/428

(57) ABSTRACT

A deployable visor for shielding a flat panel display from unwanted light impingement to aid the user of the flat panel device to effectively view information on the display. The visor includes two slideable support members to which a shade is attached. The support members are slideable within a cavity or channel in the flat panel containing device or a protective cover for such device, such that the visor can be stowed when not in use.

### BACKGROUND

Personal electronic devices that incorporate flat panel displays have become widely available in recent years. Such devices include gaming devices, smart phones and laptop computers. While the clarity and resolution of such displays has steadily increased there has always been an issue with using such devices in unfavorable lighting conditions where the light source causes glare or otherwise reduces the ability of the user to effectively view the information presented on the device's display. A common example of this is using such a device outdoors in direct sunlight, which can render the device useless as a result of not being able to effectively see what is on the display.

Current solutions for reducing glare and “wash-out” of the screen images of flat panels include adhesive films that are somewhat effective at reducing glare, but also typically reduce image quality. Such films are also typically a permanent or semi-permanent add on, that is, they are present whether the unfavorable lighting condition exists, or not, thus requiring the user of the device to partially degrade the utility of the device when it is used in favorable lighting conditions in exchange for some improvement when the device is used in unfavorable lighting conditions. Thus there exists a need for a device that will allows users of flat panel devices to effectively shade flat panel displays when the need arises without being required to permanently alter the nature of the display or the device.

### SUMMARY

In accordance with the principles of the present invention, a stowable light visor for shading a flat panel display when such a display is used in unfavorable lighting conditions, i.e. conditions that degrade the utility of the displayed information to the user. The stowable light visor includes extendable support members between which a shading material is attached. The device is stowable in a protective cover that provides protection for the flat panel-containing device, or attached directly to the flat-panel device itself. Thus when the flat panel device is used in favorable lighting conditions the stowable visor remains stowed and does not otherwise encumber the use of the flat panel device. The stowable visor, when in the extended or deployed position can be tilted to allow the user to customize the shading effect.

In one embodiment, a shading visor for a flat panel display in accordance with the resent invention includes a first and a second elongated slideable member, wherein the slideable members are disposed generally opposed to one another. The slideable members integrally mounted to a device and at least a portion thereof slide within at least one channel in the device, thus having a closed position and an open position. There is also a shade portion attached to the first and second slideable members for providing shading of at least a portion of a flat panel display in the open position and that is stowed when the slideable members are in the closed position.

Yet another embodiment of the present invention is a method of shading a flat panel display including the steps of deploying a slideable shading visor from a closed position to an open position and tilting the shading visor while in the open position to alter the location of the shade portion.

Yet another embodiment of the present invention is a method of making a shading visor for a flat panel device including the steps of mounting two generally elongated slideable support members to a device, wherein the slideable members capable of attaining an open position and a closed position, and attaching a shade portion to the support members wherein the shade portion is capable of being stowed when the slideable members are within the closed position.

### BRIEF DESCRIPTION OF THE DRAWINGS

FIG. 1 shows a front view of an embodiment of the present invention in a closed position;

FIG. 2 shows a front view of an embodiment of the present invention in an extended or open position;

FIG. 3 shows a front view of an embodiment of the present invention attached to a protective device;

FIG. 4 shows a side view of the embodiment shown in FIG. 3;

FIG. 5 shows the embodiment shown in FIG. 4 with the stowable visor retracted into the closed position;

FIG. 6 shows the embodiment shown in FIG. 4 with the stowable visor shown in a tilted position;

FIG. 7 shows an embodiment of the present invention with side panels;

FIG. 8 shows an embodiment of the present invention with side and top panels.

FIG. 9 shows a perpective view of an embodiment of the present invention. (DS Slide-up)

FIG. 10 Show a perspective view of an embodiment of the present invention. (DS Slide-up)

### DETAILED DESCRIPTION

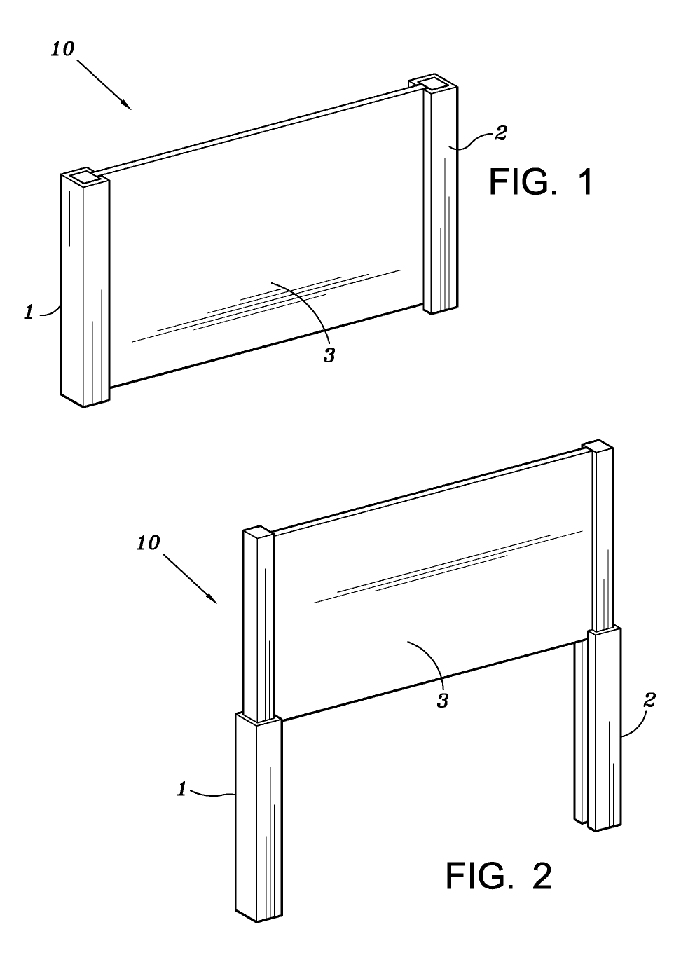

FIG. 1 shows an embodiment of the stowable visor 10 of the present invention. This embodiment includes generally elongated support members 1 and 2. This embodiment also includes a shade portion 3, which is attached to the support members 1 and 2. FIG. 2 shows on embodiment of the stowable visor 10 in an extended or open position.

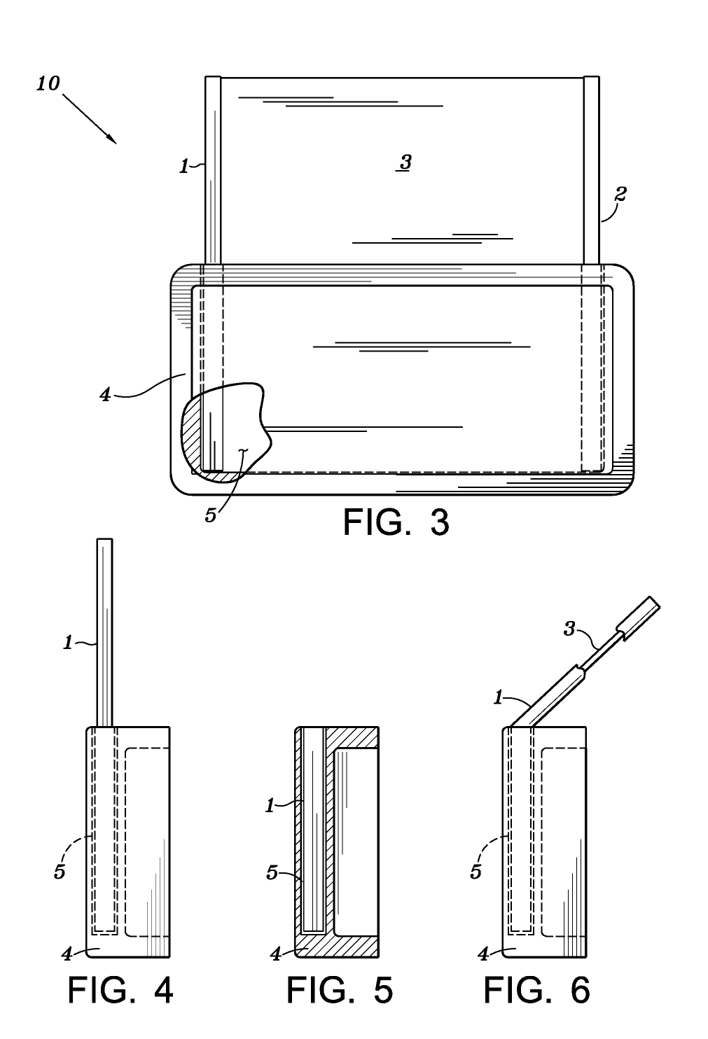

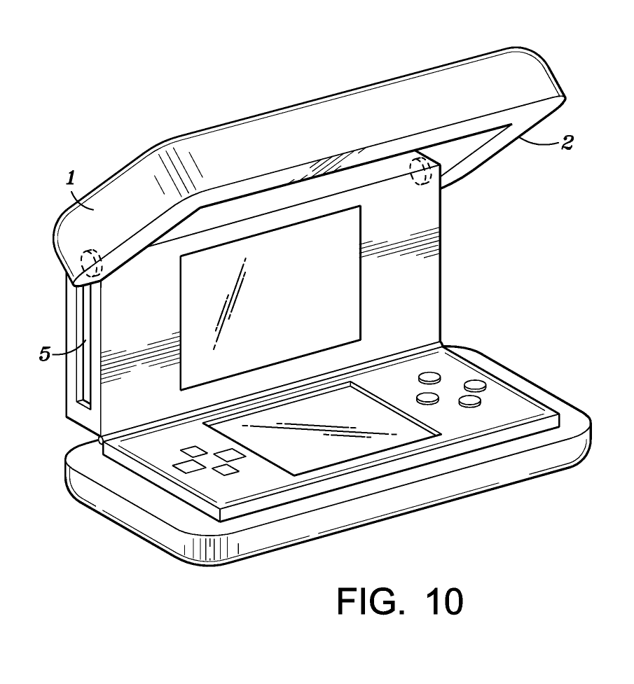

The support members may be constructed in any fashion such that they allow the shade portion 3 to be moved between an “open” configuration shown, for example, in FIGS. 3 and 4, and a “closed” or stowed configuration as exemplified in FIG. 5. As such the support members are slideable to move between the open and closed positions. Accordingly support members 1 and 2 may be composed of rigid or semi-rigid material that slides within the channel 5 shown in dotted lines in FIGS. 3, 4 and 5. The channel may also be on the sides of the device or protective cover as exemplified n FIGS. 9 and 10. As an alternative, members 1 and 2 may be telescoping with the outer portion of such a telescope anchored to allow movement within channel 5 and telescoping into the open configuration. Those skilled in the art will appreciate that there are other construction methods that would allow support members 1 and 2 to be moved between the open and closed position, and all such constructions are considered to be within the scope of the present invention. Such methods include allowing the visor to slide up in a plane generally parallel to the plane of the display and rotating out of that plane to provide shade as exemplified in FIGS. 9 and 10.

The stowable visor 10 may be incorporated either directly into the flat panel devise, or as part of an attachable protective cover 4 for the flat panel device, such as shown in FIGS. 3, 4, 5, 9 and 10. Such protective covers are presently available for flat panel-containing devices, but no such cover presently incorporates a stowable visor according to the present invention.

Incorporation of a visor of the present invention into such a protective cover may be accomplished without decreasing the shock protection provided by the protective cover. In fact, the incorporation of a void 5 for the stowage of the visor in the closed position could enhance the shock protection by providing an insulating space between the protected device and impact point with a surface when the device is dropped.

The incorporation of the visor within a flat-panel device or a protective cover prevents the need to move the visor out of the way when it is not needed in order to use the flat-panel device. As such, the visor is always available for use but poses no impediment to use of the device when the visor is not needed.

The shade portion 3 of the visor 10 may be constructed of any material that provides a reduction of intensity of undesirable lighting on the flat panel. The shade may be opaque, translucent, perforated or any other composition that will achieve the effect of providing a reduction of undesirable light impingement onto the display. Additionally, the shade portion may be removable in order to allow for replacement if the shade becomes damaged or to allow the user to select different colors and/or properties of the shade material. Alternatively the shade portion and the support members may integrated to form a single unit such that the two elements appear as a unitary structure.

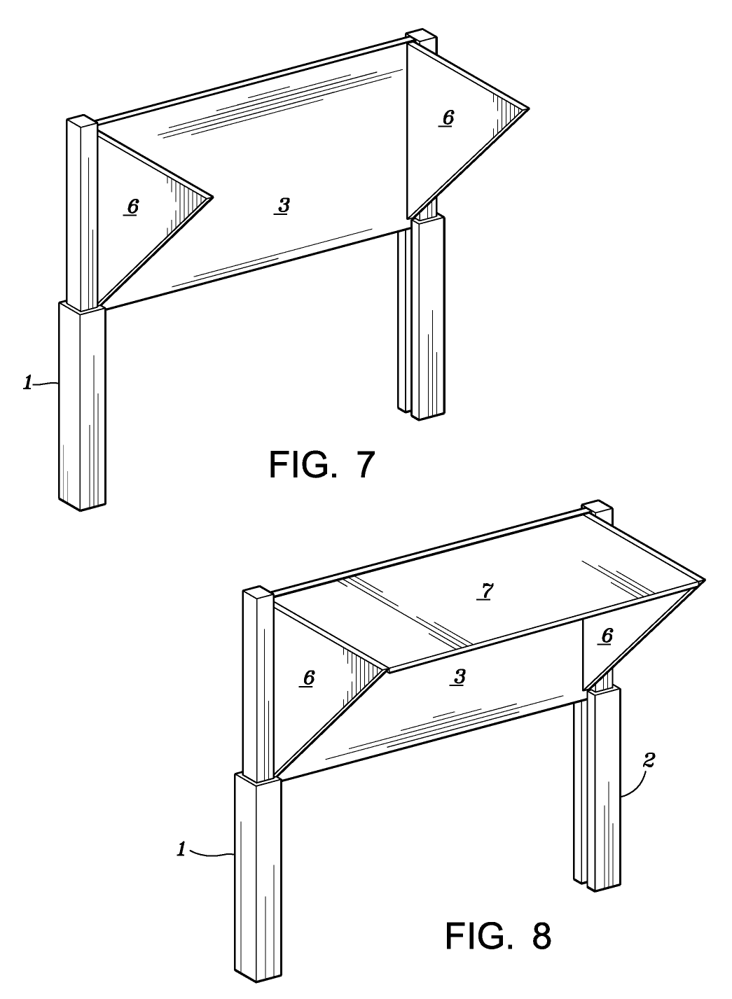

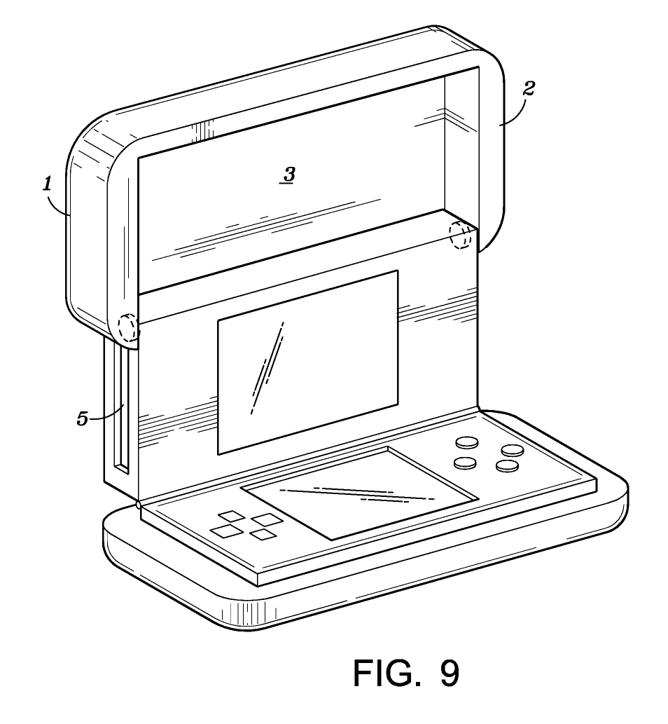

The shade portion may also contain panels 6 for reducing light impingement from the sides of the display as shown in FIG. 7. Such panels or side flaps would fold inward for stowing when the visor is placed in the closed position. Such side panels may be incorporated integrally into the shade 3, or they may be separately attached to the support members. Such side flaps may also be formed as part of larger folding shade portion as shown in FIG. 8 which includes a top panel 7.

In the open or extended position, the shade 3, in a coordinated fashion with the exposed portion of supports 1 and 2, may be tilted as, for example, as shown in FIG. 6, to allow the user to customize the shading effect provided by the visor 10.

The tilting may be accomplished by constructing the support members of a deformable material. Alternatively the tilting may be accomplished by incorporating hinges in supports 1 and 2. The hinges in the supports may be infinitely variable or ratcheted. The ratcheted embodiment may be designed to have ratcheted stops throughout the range of motion, or alternatively, with certain selectable angles, e.g., 45 or 90 degrees with respect to the plane of the display. Such hinging may also be accomplished as demonstrated in FIGS. 9 and 10.

Although embodiments of the stowable visor of the present invention have been described in detail, those skilled in the art will also recognize that various substitutions and modifications may be made without departing from the scope and spirit of the invention, as defined solely by the appended claims.

What is claimed is:

1. A shading visor for a flat panel display comprising:
a first and a second elongated slideable member, wherein the slideable members are disposed generally opposed to one another;
the slideable members integrally mounted to a device and at least a portion thereof sliding within at least one channel in the device, thus having a closed position and an open position; and
a shade portion attached to the first and second slideable members for providing shading of at least a portion of a flat panel display in the open position and that is stowed when the slideable members are in the closed position.

2. The shading visor of claim 1 wherein the device is a flat panel-containing device.

3. The shading visor of claim 1 wherein the device is a protective cover for a flat panel-containing device.

4. The shading visor of claim 1 wherein the slideable members provide one or more alternate positions relative to the display in which to shade at least a portion of the display.

5. The shading visor of claim 1 wherein the slideable members are telescoping.

6. The shading visor of claim 1 wherein the slideable members contain a hinge.

7. The shading visor of claim 1 wherein the slidable members and the shade portion are a unitary structure.

8. The shading visor of claim 1 wherein the shade portion is removable for repair or replacement.

9. The shading visor of claim 1 wherein at least a portion of the shade portion unfolds to shade at least a portion of the flat panel.

10. The shading visor of claim 9 wherein the unfolding portion constitutes side panels.

11. The shading visor of claim 10 wherein the side panels are removable.

12. The shading visor of claim 9 wherein the unfolding portion provides additional shading on three sides of the display.

13. A method of shading a flat panel display comprising the steps of :
deploying a slideable shading visor from a closed position to an open position.

14. The method of claim 13 further comprising the step of:
tilting the shading visor while in the open position to alter the location of the shade portion.

15. The method of claim 13 wherein the shading visor includes slidable members.

16. The method of claim 15 wherein the slideable members are hinged.

17. The method of claim 16 further comprising the step of:
tilting the shading visor while in the open position to alter the location of the shade portion, wherein the tilting is accomplished by adjusting the hinges in the slideable members.

18. A method of making a shading visor for a flat panel device comprising the steps of:
mounting two generally elongated slideable support members to a device, wherein the slideable members capable of attaining an open position and a closed position; and
attaching a shade portion to the support members wherein the shade portion is capable of being stowed when the slideable members are within the closed position.

19. The method of claim 17 where the slideable support members are hinged.

20. The method of claim 17 wherein the device is a flat panel-containing device.

21. The method of claim 17 wherein the device is a protective cover for a flat panel-containing device.
